(19) United States
(12) Patent Application Publication
(10) Pub. No.: US 2026/0212374 A1
(43) Pub. Date: Jul. 23, 2026

(54) GENERATION OF USAGE AND PERMISSION POLICIES ASSOCIATED WITH PRODUCTS IN AN INFORMATION PROCESSING SYSTEM

(71) Applicant: Dell Products L.P., Round Rock, TX (US)

(72) Inventors: Shibi Panikkar, Bangalore (IN); Karan Kapoor, Bangalore (IN); Guru Shyam Venkata Chatty, Bangalore (IN)

(21) Appl. No.: 19/034,094

(22) Filed: Jan. 22, 2025

(51) Int. Cl. G06Q 30/018

(52) U.S. Cl. CPC G06Q 30/0185

(57) ABSTRACT

A method includes generating first vectorized content indicative of one or more first product features and one or more first policies associated with the one or more first product features. The method further includes applying weights to a subset of the first vectorized content to generate weighted first vectorized content, the weights being derived from data indicative of one or more trends associated with the one or more first policies. The method further includes generating second vectorized content indicative of one or more second product features. The method further includes combining the weighted first vectorized content and the second vectorized content to generate combined vectorized content. The method still further includes processing the combined vectorized content into a plurality of labeled clusters based on relevancy to generate relevancy-clustered vectorized content.

### FIELD

The field relates generally to information processing systems, and more particularly to techniques for generating usage and permission requests associated with products in such information processing systems.

### BACKGROUND

Enterprises, e.g., original equipment manufacturers (OEMs), typically manufacture and provide products to their customers for use in information processing systems (e.g., data centers). A data center may be located at one or more customer sites or at one or more sites otherwise under control of the customer. OEM products may include, but are not limited to, hardware products (e.g., servers, storage arrays, or components thereof), software products (e.g., operating systems, application programs, or other types of software), and combinations thereof (e.g., servers and/or storage arrays with software loaded thereon).

Given a wide variety of products provided by an OEM or other supplier, and continuing product improvements, generating software that manages use, access, and functionalities by a customer of such products face significant technical challenges.

### SUMMARY

Illustrative embodiments provide generation of usage and permission policies associated with a product in an information processing system.

For example, in one or more illustrative embodiments, a method includes generating first vectorized content indicative of one or more first product features and one or more first policies associated with the one or more first product features. The method further includes applying weights to a subset of the first vectorized content to generate weighted first vectorized content, the weights being derived from data indicative of one or more trends associated with the one or more first policies. The method further includes generating second vectorized content indicative of one or more second product features. The method further includes combining the weighted first vectorized content and the second vectorized content to generate combined vectorized content. The method still further includes processing the combined vectorized content into a plurality of labeled clusters based on relevancy to generate relevancy-clustered vectorized content.

In one or more additional illustrative embodiments, the relevancy-clustered vectorized content can be similarity searched to find second product feature-relevant vectorized content that can be used to train a model, which can then be used to generate one or more second policies in response to a prompt.

Advantageously, illustrative embodiments provide, inter alia, an improved usage and permission system that autonomously generates usage and permission policies for new product features using generative artificial intelligence (machine learning) model techniques. Based on the relevancy-focused vectorized content associated with the new product features, the AI model (e.g., a large language model or LLM) is less likely to yield inaccurate prompt results thus leading to an improvement in the utilization of hardware/software resources of the underlying computing system that executes the AI model (e.g., the LLM prompt will not have to be re-executed based on inaccurate results in a previous execution).

These and other illustrative embodiments include, without limitation, methods, apparatus, networks, systems and processor-readable storage media.

### BRIEF DESCRIPTION OF THE DRAWINGS

FIG. 1 illustrates an information processing system configured to generate usage and permission policies in accordance with one or more illustrative embodiments.

FIG. 2 illustrates a methodology to generate usage and permission policies in accordance with one or more illustrative embodiments.

FIGS. 3 and 4 illustrate respective parts of a process to generate usage and permission policies in accordance with one or more illustrative embodiments.

FIGS. 5A through 5D illustrate vector content and cluster formation for an example of a usage and permission policy generation system according to one or more illustrative embodiments.

FIGS. 6A through 6F illustrate pseudocode for implementing a methodology to generate usage and permission policies in accordance with one or more illustrative embodiments.

FIGS. 7 and 8 illustrate examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud and edge computing and storage systems, as well as other types of processing systems comprising various combinations of physical and virtual processing resources.

As mentioned, software that manages customer use, access, functionalities, etc. of products provided by an OEM or other supplier faces technical challenges. Such software that manages usage can define various parameters. As used herein, examples of such software parameters can include usage parameters, e.g., parameters defining the number of users or devices (sometimes called “seats”) that can use a software product, or the number of instances of the software product that can be used (e.g., how many users are licensed to use the software, and what are their identities). Other examples of such software parameters can include permission parameters, e.g., parameters defining levels of access or permissions that each of the users have to the software product (e.g., what functionalities of the software product are each user entitled to use). Similar usage and permission parameters can be applied to hardware products, as well as combinations of hardware and software products. In some examples, one or more usage parameters may be defined as part of a product license or product license model, while one or more permission parameters may be referred to as entitlements which can also be defined in a product license or defined separately.

Consider an OEM that manufactures and distributes a large number of storage and server (compute) products with variations within each product. Policies for customer usage and permissions of such wide ranging products can, themselves, also be wide ranging. Examples of such policies may include:
1. Resource-based policy:
   Storage product:
      (i) Per-GB (Gigabyte) Storage: Charge based on the amount of storage space used. This can be tiered with different costs for different storage classes (e.g., standard, premium, archival).
      (ii) Per-IOPS (Input/Output Operations Per Second): Charge based on the number of read/write operations the server performs. This addresses performance-intensive workloads.
      (iii) Storage tiered: Offers different storage tiers with varying performance and cost, e.g., a basic tier with limited IOPS and a high-performance tier with unlimited IOPS, but at a higher cost.
   Compute product:
      (i) Per-CPU Core: Charge based on the number of CPU (central processing units) cores utilized. This is common for high-performance computing needs.
      (ii) Per-vCPU (virtual CPU): Charge for virtual cores assigned to virtual machines running on the server. This is particularly suitable for virtualized environments.
      (iii) Per-Hour/Per-Minute Usage: Charge based on the actual time the server's resources are utilized. This can be tracked via monitoring tools and provides granular charging.
2. Usage-based policy:
   (i) Hybrid Metering: Combine resource-based and usage-based metrics. For example, charge per GB of storage used, but also include a flat fee for a certain number of compute hours per month.
   (ii) Pay-as-You-Go: Offer a pay-as-you-go option where users are charged only for the actual resources they consume in real-time. This can be suitable for short-term or unpredictable workloads.
3. Perpetual policy:
   (i) Feature-based tier includes different tiers of service based on the available features. For example:
      (a) Basic tier includes essential storage and basic compute capabilities.
      (b) Standard tier includes increased storage capacity, more powerful compute, and basic network features.
      (c) Enterprise tier includes maximum storage, premium compute, advanced security, and advanced networking features.
   (ii) Performance-based tier includes tiers based on performance parameters. For example:
      (a) Entry-level tier includes limited storage capacity and compute power, suitable for basic workloads.
      (b) Performance tier includes enhanced storage and compute resources designed for demanding applications.
      (c) Application-specific tier tailored based on specific use cases or applications, e.g., database server tier optimized for database workloads with large storage and high IOPS.
      (d) Media server tier optimized for media processing with large storage and high bandwidth.
4. Subscription-based policy:
   (i) Monthly/yearly subscriptions offer fixed monthly or yearly subscription fees that provide access to a defined set of storage and compute resources. This can include options for scaling up resources as needed.
   (ii) Capacity bundles offer subscription packages with pre-configured storage and compute capacity. This can be a good option for customers with predictable needs.
   (iii) Flexible subscription plans allow customers to customize their subscriptions by selecting specific storage and compute options, paying only for what they use.
5. Hybrid Models:
   (i) Combination of perpetual and resource-based policies combine feature-based tiers with resource-based pricing. For example, assume a standard tier includes 1 TB of storage and two CPU cores, with additional storage and compute available for an extra charge.
   (ii) Subscription with usage-based overages offer a base subscription fee but charge additional fees for exceeding the allocated resources. This can be a good option for customers with fluctuating usage.

These are a few variations of previous usage and permission policies for existing storage products. In a large OEM, the product variations are quite high and previous product data sets grow in 10 to 100s of GBs. Out of all these policies, some will be selling high in the market, and some others have partner specific interests (with additional variations and priorities). So, the marketing trends and partner's interest will be other factors that should be considered while defining the usage and permission policies of a new product. Another impacting factor is realized to be how products are onboarded in a supply chain for fulfillment systems.

In short, there are many variations in the usage and permission policies for the current products in an organization. Thus, determining and generating usage and permission policies (e.g., licensing policies) for new products presents significant challenges within an organization's underlying information processing systems. The process is intricate and time-consuming, utilizing hardware/software resources of the underlying information processing systems, exacerbated by the need to integrate comprehensive knowledge across diverse domains and the myriad variations of existing policies and marketing priorities. Suboptimal decisions at this stage often result in costly adjustments post-launch in underlying information processing systems, impacting both time and operational efficiency. These technical challenges lead to a burdensome increase in system processing, storage, and networking overhead.

Illustrative embodiments overcome the above and other technical drawbacks of existing usage and permission policy generation systems by providing an improved usage and permission policy generation system that uses a classical artificial intelligence (AI) methodology along with generative AI techniques in a new product introduction (NPI) life cycle. The term “artificial intelligence” may be interchanged herein with the term “machine learning.”

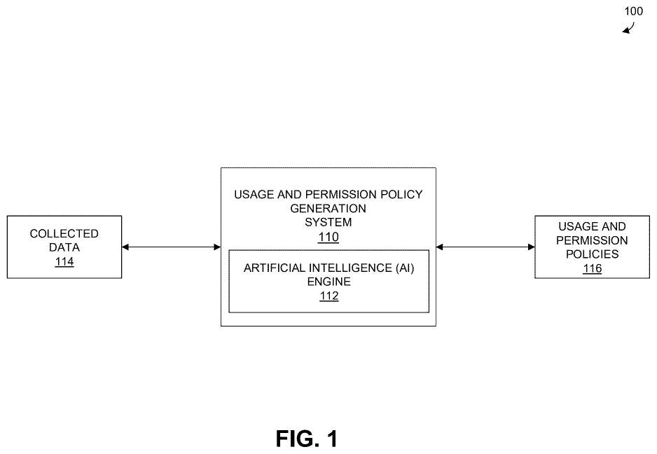

FIG. 1 illustrates an information processing system 100 configured to generate usage and permission policies in accordance with one or more illustrative embodiments. As shown, information processing system 100 includes a usage and permissions policy generation system 110 configured with an AI engine 112 which receives collected data 114 from a plurality of sources. Usage and permissions policy generation system 110, using AI engine 112, generates one or more usage and permission policies 116. In some embodiments, usage and permissions policy generation system 110 may be considered a licensing and entitlement system.

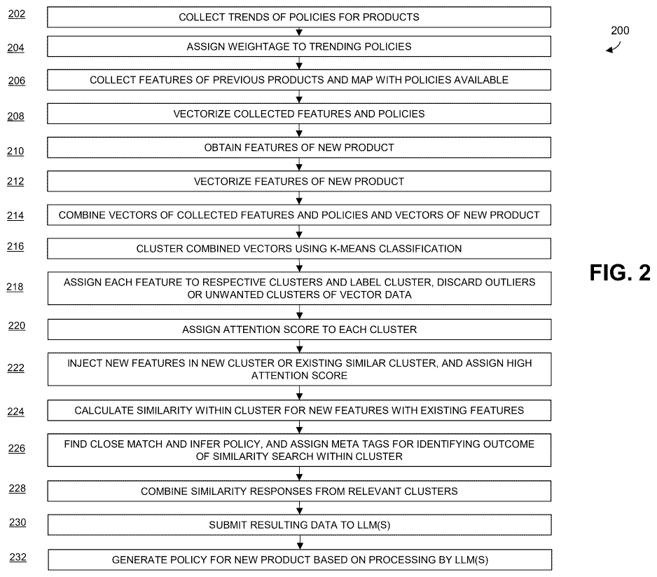

FIG. 2 illustrates a methodology 200 to generate usage and permission policies in accordance with one or more illustrative embodiments. In some embodiments, methodology 200 is implemented by usage and permissions policy generation system 110 configured with AI engine 112 of FIG. 1. Each step of methodology 200 will be generally described below, followed by detailed examples in the context of the subsequent figures.

Step 202 collects marketing trends of different usage and permission policies in the market for a new product. The product can be an in-house (OEM) product as well as a product of an organization external to the OEM. Data indicative of respective interests of partners of the OEM can be collected as well. In some embodiments, partners may refer to entities with which the OEM cooperates to fabricate a product (e.g., third party manufacturers, vendors, suppliers, distributors, etc.).

Step 204 assigns weightage to usage and permission policies that are trending in the relevant market for the product.

Step 206 collects features of previous products (e.g., features of products released prior to the new product) and maps them with available usage and permission policies. This step can involve collection of data on the order of 100 of GBs (gigabytes) or TBs (terabytes). In some embodiments, features may refer to customer-utilizable functionalities of a product.

Step 208 vectorizes the features and usage and permission policies that collected in the previous steps. Vectorization is a process of converting input data from its raw format (e.g., text) into vectors of real numbers which is a format that AI (machine learning) models typically support.

Step 210 obtains the features of the new product.

Step 212 vectorizes the features of the new product.

Step 214 combines the vectors generated from step 208 and step 210.

Step 216 clusters the combined vectors using a k-means classification choosing an appropriate number of cluster (k) and then grouping vectors around the new product features. K-means classification (or clustering) is a machine learning algorithm that groups data points into clusters based on their similarity.

Step 218 assigns each feature to the respective clusters and labels the cluster, and discards the outliers or unwanted clusters of vector data.

Step 220 assigns an attention score to each cluster based on a market analysis and partner priorities (interests, as mentioned above in step 202). An attention score is a numerical value that indicates the importance of a part of input data in a model. More particularly, attention scores are used in machine learning and natural language processing (NLP) to help models focus on relevant information.

Step 222 enables consideration of the fact that there can be new features that are not part of previous features, which would otherwise be identified as outliers. Accordingly, these new features are injected in the new cluster or existing similar cluster, and a relatively high attention score is assigned to the cluster so that a similarity search will give more attention to the new feature.

Step 224 calculates the similarity within a cluster (e.g., smaller size and more accurate) for the new features with the existing features.

Step 226 finds the close match (e.g., use trial and error for the threshold) and infers the usage and permission policy (e.g., license). Metatags (metadata) are assigned for identifying the outcome of the similarity search within the cluster. Thus, the resultant vector data is exceedingly small compared to the entire previous feature/policy embeddings.

Step 228 combines similarity responses from all relevant clusters. This vector data is relevant, small, and dense—e.g., suitable for any large language model (LLM) as embeddings for usage and permission policy generation.

Step 230 submits the vectors with previously-assigned metadata, and attention scores (priority), to an LLM (e.g., Llama) to generate the usage and permission policy in priority descending order with proper prompt (e.g., “Generate the usage and permission policy in descending priority-based order, e.g., highest priority policy should be on the top of the list.”)

Step 232 executes the LLM to generate the usage and permission policy according to the prompt requests. Also, questions can be asked such as “Show me all licensable features,” “Show me all existing features,” “Show me the marketing trends,” etc.). Since the system has the relevant vectorized contents with proper metadata and attention weightage score, the LLM provides a highly accurate result. Additionally, since the vector content contains only related features and policies of new products, even a local on-premises model will be able to handle the sufficiently request.

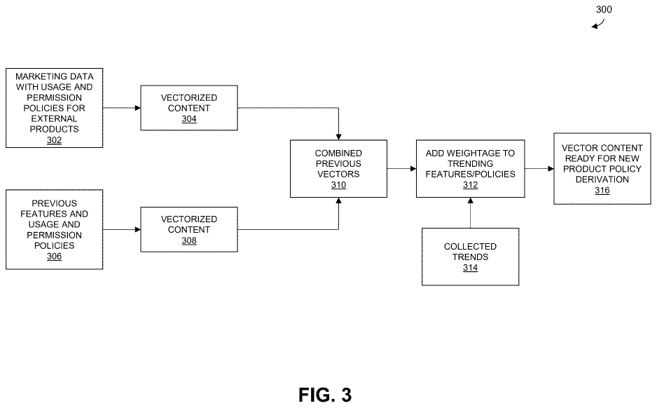

Referring now to FIGS. 3 and 4, respective parts of a process to generate usage and permission policies in accordance with one or more illustrative embodiments are shown.

More particularly, FIG. 3 depicts a process 300 for generating all previous products, external product's features, policy vectorized content and add weightage using the trending policy information. This weightage can be represented as a multiplier that adjusts the feature vectors or the similarity scores. In some embodiments, process 300 is done in a periodic manner such as when fresh marketing research is published, a change happened in the priority or new product, or new features are introduced. This vector content is used for all new product introduction (NPI) processes. Process 300 corresponds to steps 202 through 208 of methodology 200 in FIG. 2.

As shown, step 302 collects marketing data with usage and permission policies for external products. The collected data is vectorized in step 304. Similarly, step 306 collects previous features and usage and permission policies, which is vectorized in step 308. Step 310 combines the vectors of steps 304 and 308. Weightage is added to trending features and/or policies in step 312 in accordance with trends collected in step 314. Step 316 outputs the vector content ready for new product policy derivation in a process 400 of FIG. 4.

More particularly, process 400 of FIG. 4 obtains all features of the new product and combines them with vectors of process 300 for classification and generation of the new usage and permission policy. Process 400 corresponds to steps 210 through 230 of methodology 200 in FIG. 2.

As shown, step 402 represents vector content ready for new product policy derivation (e.g., from step 316 of process 300). New product features are obtained in step 404 and vectorized in step 406. Vectors from steps 402 and 406 are combined in step 408. Step 410 classifies (clusters) the vectors from step 408 using a k-means algorithm (or any other suitable clustering algorithm). Relevant clusters are labeled in step 412 and new features in outliers, if any, are injected into the nearest cluster in step 414. Step 416 outputs the resulting vector content for the LLM to process as described above. Advantageously, the resulting vector content is the most relevant clusters that are suitable for similarity search for the new product's features. This results in making the size of vector embeddings exceedingly small and the most relevant for further processes. Vector embeddings are numerical representations of input data such as words, sentences, and/or other data, that capture their meanings and relationships such that a generative AI model (e.g., LLM) can process the input data.

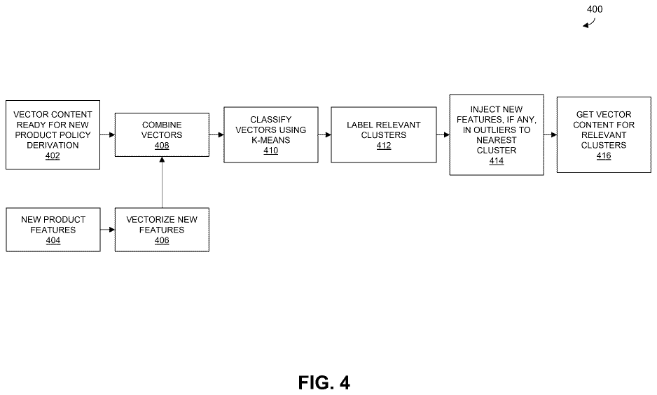

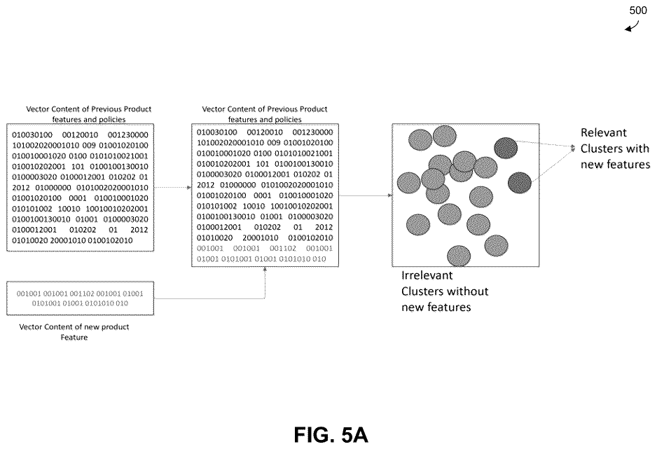

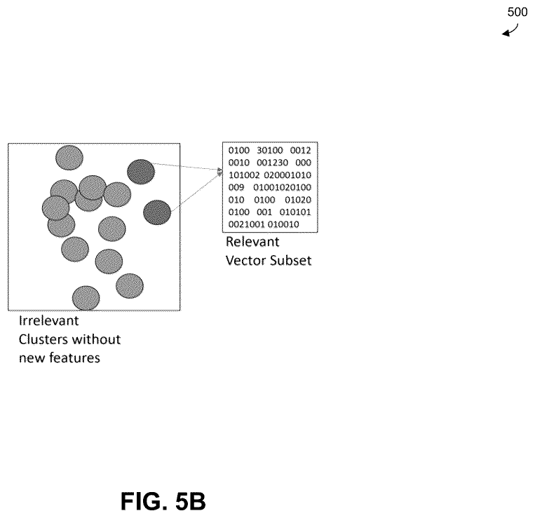

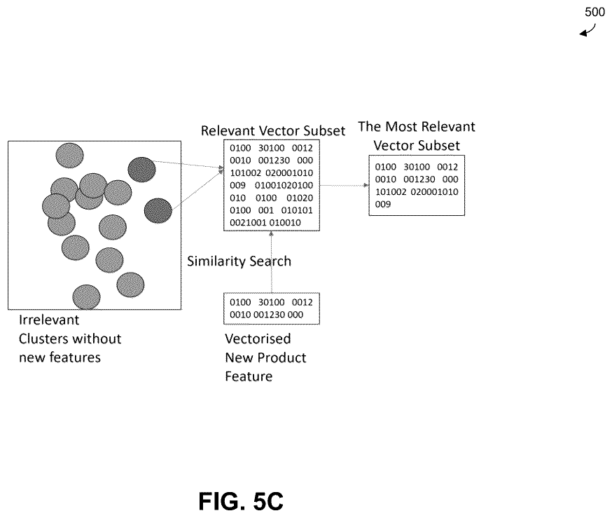

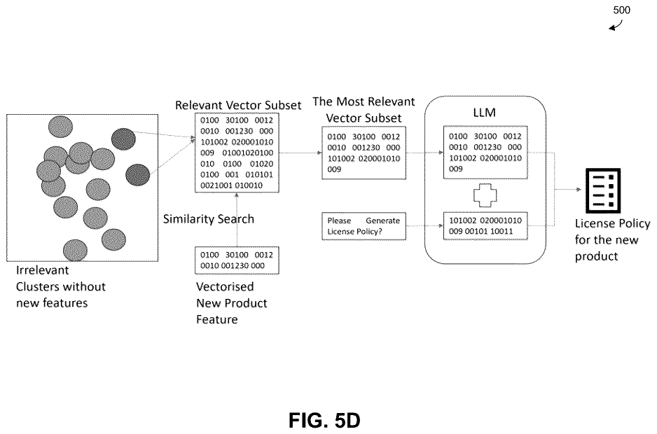

FIGS. 5A through 5D illustrate vector content and cluster formation process 500 for an example of a usage and permission policy generation system according to one or more illustrative embodiments. More particularly, as shown in FIGS. 5A and 5B, process 500 assigns labels for each cluster, and attention scores can be added for features in each cluster. This will make the similarity search more accurate within a cluster. The vectors are combined from each cluster. This will be most dense vector with respect to the new feature of the product.

A similarity search with new features is then conducted as illustrated in FIG. 5C. More particularly, the process vectorizes new features and conducts the similarity search in the relevant vector subset. The process returns the vector above a certain threshold (e.g., the threshold can be set relatively low as the original vector is already a result of the relevant cluster). The outcome vector is considered the most relevant vector for generating the usage and permission policy for the new product. More particularly, this is the most relevant content of the related features and usage and permission policies for the features of the new product. This content is exceedingly small compared to the original vector content of all features and policies, which advantageously serves as improved embedding content that is passed as a prompt to an LLM, as shown in FIG. 5D, which generates the usage and permission policy in a desired or required format such as, for example, a text file, JavaScript Object Notation (JSON), or Extensible Markup Language (XML).

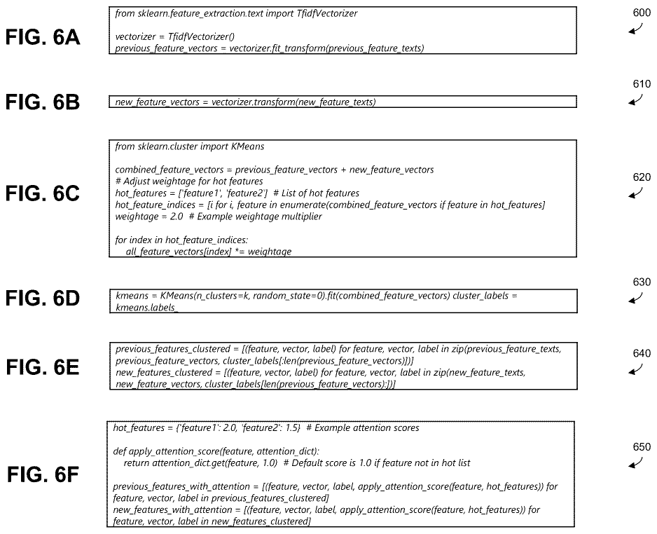

FIGS. 6A through 6F illustrate pseudocode 600 for implementing a methodology to generate usage and permission policies in accordance with one or more illustrative embodiments. In some embodiments, the pseudocode in FIGS. 6A through 6F can be used to implement the above processes and methodologies in FIGS. 2 through 5D.

Pseudocode 600 in FIG. 6A collect all previous features, relevant external product features and related policies, vectorizes the results using technology such as, but not limited to, term frequency-inverse document frequency (TF-IDF), Wordt2vec, BERT, etc. FIG. 6A depicts TF-IDF. In one use case, further described below, the node wise storage by product type can be used, e.g., storage in one node and compute in another node, in order to yield better data segregation.

Pseudocode 610 in FIG. 6B vectorizes new product features. The two vectors are combined by pseudocode 620 in FIG. 6C and assigned the weightage according to the market analysis. This step improves the clustering as shown in pseudocode 630 in FIG. 6D, as well as the similarity search.

Pseudocode 640 in FIG. 6E assigns each feature to its respective cluster based on the clustering results, and applies labels for relevant clusters.

Pseudocode 650 in FIG. 6F applies the relevant attention score to the vectors in the cluster according to the features. This enhances the relevance of the similarity search for new features.

The process now has the cluster of vectors on which the LLM will perform a similarity search and obtain the accurate usage and permission policy features with a weighted score and attention score.

In some embodiments, a cosine similarity search can be performed on the previous vectors in the weighted and attention scored cluster with the vector of new product feature. The similar vectors are obtained above a threshold, e.g., start with 85%, since most of the vectors will yield the similarity as the density is too high in the identified cluster.

The resultant vector is stored. This is the embedded vector that will be used for policy generation queries with the LLM (e.g., Llama or Mistral).

The LLM can be queried with a prompt such as:
“Please construct a licensing policy with descending priority.”

This will return a licensing (usage and permission) policy in a natural language that stakeholders can leverage to start with and make informed decisions.

Since priority is set as the attention scores of the features, the LLM can now provide more accurate results for multiple prompts such as feature details, highest trends, etc.

To further illustrate the usage and permission generation methodology (“methodology”) described herein, assume introduction of a storage backup product which has mainly three features: (i) object storage backup; (ii) block storage backup; and (iii) file storage backup.

Previous products and policies will have numerous variations other than storage products. The vector data will be on the order of 100s of GBs.

1. To load all variations in an embedding will be challenging in performance as well as token limitations.

2. Even if all the variations could be loaded, the results can be hallucinating as multiple products will have object, file and block names but nothing to do with the storage solution. Thus, existing embedding solutions will not work.

Thus, in accordance with one of more illustrative embodiments described herein, the improved methodology vectorizes the backup product feature and adds the vector content to the previous vectorized data. The combined data is clustered using k-means clustering. Now, the vector is clustered based on the new product features, resulting in vector clusters such as:
1. Resource-Based Storage Cluster:
   (i) Per-GB Storage: Charge based on the amount of storage space used. This can be tiered with different prices for different storage classes (e.g., standard, premium, archival).
   (ii) Per-IOPS: Charge based on the number of read/write operations the server performs. This addresses performance-intensive workloads.
   (iii) Storage Tiered Pricing: Offer different storage tiers with varying performance and cost. For example, a basic tier with limited IOPS and a high-Performance tier with unlimited IOPS, but at a higher cost.
2. Resource Based Compute Storage
(i) Per-CPU Core: Charge based on the number of CPU cores utilized. This is common for high-performance computing needs.
(ii) Per-vCPU (Virtual CPU): Charge for virtual cores assigned to virtual machines running on the server. This is suitable for virtualized environments.
(iii) Per-Hour/Per-Minute Usage: Charge based on the actual time the server's resources are utilized. This can be tracked via monitoring tools and provides granular pricing.
   3. Usage-Based Policies:
(i) Hybrid Metering: Combine resource-based and usage-based metrics. For example, charge per GB of storage used, but also include a flat fee for a certain number of compute hours per month.
(ii) Pay-as-You-Go: Offer a pay-as-you-go option where users are charged only for the actual resources they consume in real-time. This can be attractive for short-term or unpredictable workloads.

4. Perceptual Policies:
(i) Feature-Based Tiers: Offer different tiers of service based on the available features. For instance:
   (a) Basic tier includes essential storage and basic compute capabilities.
   (b) Standard tier includes increased storage capacity, more powerful compute, and basic network features.
   (c) Enterprise tier includes maximum storage, premium compute, advanced security, and advanced networking features.
   (d) Performance-based tiers offer tiers based on performance parameters. For example:
      (1) Entry-level tier offers limited storage capacity and compute power, suitable for basic workloads.
      (2) Performance tier offers enhanced storage and compute resources, designed for demanding applications.
      (3) Application-specific tiers are tailored tiers based on specific use cases or applications. For example, a database server tier optimized for database workloads with large storage and high IOPS, and media server tier optimized for media processing with large storage and high bandwidth.

5. Subscription-Based Storage and Policies:
(i) Monthly/yearly subscriptions offer fixed monthly or yearly subscription fees that provide access to a defined set of storage and compute resources. This can include options for scaling up resources as needed.
(ii) Capacity bundles offer subscription packages with pre-configured storage and compute capacity. This can be a good option for customers with predictable needs.
(iii) Flexible subscription plans allow customers to customize their subscriptions by selecting specific storage and compute options, paying only for what they use.

5. Hybrid Models based policies:
(i) Combination of perceptual and resource-based policies that combine feature-based tiers with resource-based pricing. For example, a standard” tier includes 1TB of storage and two CPU cores, with additional storage and compute available for an extra charge.
(ii) Subscription with usage-based overages offer a base subscription fee but charge additional fees for exceeding the allocated resources. This can be a good option for customers with fluctuating usage.

The methodology analyzes the clusters, avoids the outliers/unrelated data, and labels the clusters and assign the attention scores from market trend studies, e.g., “flexible pricing plan sale is highest” and then “usage-based overage,” etc. Now, the vector inside this cluster is a dense cluster, with the relevant vectors.

Further, a similarity search is performed based on the backup storage features and then the vectors above threshold are obtained. Assume the threshold is set 85%-mostly all of the above vectors will match above 85%. In some other use cases, the similarity search will result in a subset of the above vectors, which will be the most relevant vectorized content. The token in this vector content will be fairly low. Now, the methodology is ready to use this vector as the embedding and ask the LLM to form the policy for the new product.

For example, assume an LLM prompt is: “Tell me the highest priority policy for a backup product based on the given features.”

The answer from LLM (e.g., Llama2) can be:
Suggested policy for backup product:
   (i) Backup object storage might primarily use Per-GB Storage and Feature-Based Tiers (e.g., different tiers for basic backup versus advanced backup with encryption).
(ii) Backup block storage could benefit from Resource-Based Licensing (Per-IOPS) and Hybrid Metering (combining usage-based overages for compute with fixed storage costs).
(iii) Backup file storage may align well with Subscription-Based Licensing, providing customers with options for fixed monthly plans or flexible usage-based subscriptions.

If you Other LLMs may be used, such as GPT 3.5 or 4.0, in order to get a better natural language-based answer.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

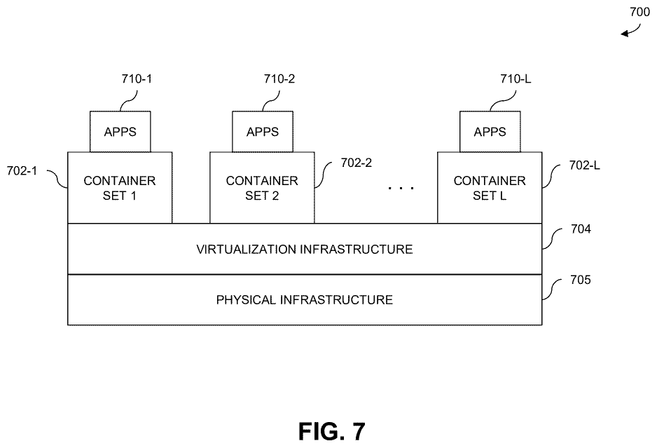

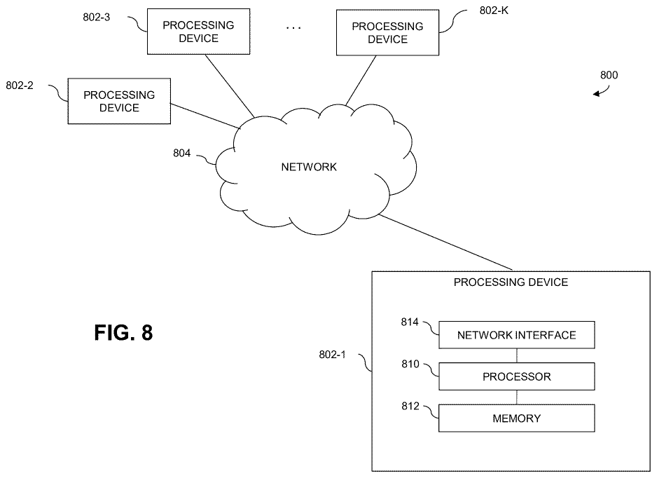

Illustrative embodiments of processing platforms utilized to implement functionality for generating usage and permission policies associated with a product will now be described in greater detail with reference to FIGS. 7 and 8. Although described in the context of information processing system environment mentioned herein, these platforms may also be used to implement at least portions of other information processing systems in other embodiments.

FIG. 7 shows an example processing platform comprising infrastructure 700. Infrastructure 700 comprises a combination of physical and virtual processing resources that may be utilized to implement at least a portion of the information processing system 100 in FIG. 1. Infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

Infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 may comprise respective VMs, respective sets of one or more containers, or respective sets of one or more containers running in VMs.

In some implementations of the FIG. 7 embodiment, the VMs/container sets 702 comprise respective VMs implemented using virtualization infrastructure 704 that comprises at least one hypervisor. A hypervisor platform may be used to implement a hypervisor within the virtualization infrastructure 704, where the hypervisor platform has an associated virtual infrastructure management system. The underlying physical machines may comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system environments mentioned herein may each run on a computer, server, storage device or other processing platform element. A given such element may be viewed as an example of what is more generally referred to herein as a “processing device.” Infrastructure 700 shown in FIG. 7 may represent at least a portion of one processing platform. Another example of such a processing platform is processing platform 800 shown in FIG. 8.

The processing platform 800 in this embodiment comprises at least a portion of information processing system 100 and includes a plurality of processing devices, denoted 802-1, 802-2, 802-3, . . . 802-K, which communicate with one another over a network 804.

The network 804 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 802-1 in the processing platform 800 comprises a processor 810 coupled to a memory 812.

The processor 810 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 812 may comprise random access memory (RAM), read-only memory (ROM), flash memory or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and information processing system environments mentioned herein may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for application monitoring with predictive anomaly detection and fault isolation as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, edge computing environments, applications, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
generating first vectorized content indicative of one or more first product features and one or more first policies associated with the one or more first product features;
applying weights to a subset of the first vectorized content to generate weighted first vectorized content, the weights being derived from data indicative of one or more trends associated with the one or more first policies;
generating second vectorized content indicative of one or more second product features;
combining the weighted first vectorized content and the second vectorized content to generate combined vectorized content; and
processing the combined vectorized content into a plurality of labeled clusters based on relevancy to generate relevancy-clustered vectorized content.

1. The method of claim 1, further comprising:
assigning one or more attention scores to the relevancy-clustered vectorized content.

2. The method of claim 1, further comprising:
adjusting the relevancy-clustered vectorized content by inserting vector content indicative of one or more of the second product features that differ from first product features into the relevancy-clustered vectorized content.

3. The method of claim 3, further comprising:
performing a similarity search of the relevancy-clustered vectorized content, based on the one or more second product features, to find second product feature-relevant vectorized content.

4. The method of claim 4, further comprising:
training a model by inputting the second product feature-relevant vectorized content to the model to configure the model to generate, in response to a prompt, one or more proposed second policies associated with the one or more second product features.

6. The method of claim 5, wherein the model comprises a large language-based machine learning model.

7. The method of claim 5, wherein the one or more first policies and the one or more proposed second policies comprise usage and permission policies.

8. The method of claim 1, wherein the processing of the combined vectorized content into a plurality of labeled clusters based on relevancy to generate relevancy-clustered vectorized content further comprises clustering the combined vectorized content via a k-means clustering algorithm.

9. An apparatus comprising:
at least one processing platform comprising at least one processor coupled to at least one memory, the at least one processing platform, when executing program code, is configured to:
generate first vectorized content indicative of one or more first product features and one or more first policies associated with the one or more first product features;
apply weights to a subset of the first vectorized content to generate weighted first vectorized content, the weights being derived from data indicative of one or more trends associated with the one or more first policies;
generate second vectorized content indicative of one or more second product features;
combine the weighted first vectorized content and the second vectorized content to generate combined vectorized content; and
process the combined vectorized content into a plurality of labeled clusters based on relevancy to generate relevancy-clustered vectorized content.

10. The apparatus of claim 9, wherein the at least one processing platform, when executing program code, is further configured to:
assign one or more attention scores to the relevancy-clustered vectorized content.

11. The apparatus of claim 9, wherein the at least one processing platform, when executing program code, is further configured to:
adjust the relevancy-clustered vectorized content by inserting vector content indicative of one or more of the second product features that differ from first product features into the relevancy-clustered vectorized content.

12. The apparatus of claim 11, wherein the at least one processing platform, when executing program code, is further configured to:
perform a similarity search of the relevancy-clustered vectorized content, based on the one or more second product features, to find second product feature-relevant vectorized content.

13. The apparatus of claim 12, wherein the at least one processing platform, when executing program code, is further configured to:
train a model by inputting the second product feature-relevant vectorized content to the model to configure the model to generate, in response to a prompt, one or more proposed second policies associated with the one or more second product features.

14. The apparatus of claim 13, wherein the model comprises a large language-based machine learning model.

15. The apparatus of claim 13, wherein the one or more first policies and the one or more second policies comprise usage and permission policies.

16. The apparatus of claim 9, wherein the processing of the combined vectorized content into a plurality of labeled clusters based on relevancy to generate relevancy-clustered vectorized content further comprises clustering the combined vectorized content via a k-means clustering algorithm.

17. A computer program product comprising a non-transitory processor-readable storage medium having stored therein program code of one or more software programs, wherein the program code when executed by at least one processing device causes the at least one processing device to:
generate first vectorized content indicative of one or more first product features and one or more first policies associated with the one or more first product features;
apply weights to a subset of the first vectorized content to generate weighted first vectorized content, the weights being derived from data indicative of one or more trends associated with the one or more first policies;
generate second vectorized content indicative of one or more second product features;
combine the weighted first vectorized content and the second vectorized content to generate combined vectorized content; and
process the combined vectorized content into a plurality of labeled clusters based on relevancy to generate relevancy-clustered vectorized content.

18. The computer program product of claim 17, wherein the program code when executed by at least one processing device further causes the at least one processing device to:
adjust the relevancy-clustered vectorized content by inserting vector content indicative of one or more of the second product features that differ from first product features into the relevancy-clustered vectorized content.

19. The computer program product of claim 18, wherein the program code when executed by at least one processing device further causes the at least one processing device to:
perform a similarity search of the relevancy-clustered vectorized content, based on the one or more second product features, to find second product feature-relevant vectorized content.

20. The computer program product of claim 19, wherein the program code when executed by at least one processing device further causes the at least one processing device to:
train a model by inputting the second product feature-relevant vectorized content to the model to configure the model to generate, in response to a prompt, one or more proposed second policies associated with the one or more second product features.
